(19) United States
(12) Patent Application Publication
(10) Pub. No.: US 2010/0253520 A1
(43) Pub. Date: Oct. 7, 2010

(54) DEVICE, METHOD AND SYSTEM FOR FORWARDING DATA FROM RFID DEVICES

(75) Inventor: Mika Lauronen, Villala (FI)

Correspondence Address: YOUNG & THOMPSON, 209 Madison Street, Suite 500, Alexandria, VA, 22314, US

(73) Assignee: CONTROLMATIC OY LTD., Joensuu (FI)

(21) Appl. No.: 12/746,325

(22) PCT Filed: Dec. 4, 2008
(86) PCT No.: PCT/FI08/50711

§ 371 Date: Jun. 4, 2010

(30) Foreign Application Priority Data
Dec. 4, 2007 (FI) 20075875

(51) Int. Cl. G08B 13/14; H04W 84/02

(52) U.S. Cl. 340/572.1; 370/338

(57) ABSTRACT

A device, method and system for forwarding data from a number of RFID devices, wherein data, e.g. ID and/or sensor data, is wirelessly received from the RFID devices (106) via radiofrequency communication and stored by a master device (104) that after receipt of a radio frequency activation signal transmits the data over a WLAN connection towards a remote recipient.

### FIELD OF THE INVENTION

The present invention relates generally to wireless information transfer. In particular the invention pertains to obtaining and forwarding data in the context of radio frequency identification (RFID) technology.

### BACKGROUND

RFID technology concerns identification techniques enabling remote data retrieval via radio frequencies from RFID devices hereinafter also referred to as “tags”. The tags can be included in or attached to target objects such as different kinds of products or humans/animals that are to be identified. In addition to mere identifying a tag may incorporate or it may at least be functionally connected to one or more sensors providing measurement data to be passed forward by the communication means of the tag. A device called an RFID reader comprises an RF transceiver, or at least a receiver in the case of active tags described hereinafter, which can be used to remotely acquire the data from the tag whereby the physical distance between the reader and the tag may vary from few centimeters to hundreds of meters depending on the nature of the tag and prevailing conditions such as the presence of obstacles or interference in the radio path.

Passive tags include a transmit circuit that powers up upon absorbing radiated energy from a reader device so as to transmit the ID and optional other information to the reader via a local antenna, meanwhile active tags include, or are at least connected to, a power source of their own, which provides necessary energy for the internal chip(s) and data transmission. Such power source may be a replaceable, e.g. disposable, and/or rechargeable battery, for example. There are also so-called semi-passive tags that indeed have a power supply for limited use but also received radiation is utilized for powering up local functionalities. Active tags may have a range of hundreds of meters whereas passive tags just basically reflecting part of the incoming energy are limited to much shorter communication distances.

The tags may comprise processing and memory means for processing and storing instructions and other data, and a data transfer means including an antenna for sending data to external devices such as readers. The various means may be integrated in one or more chips, for example. In addition the tags may incorporate or be at least functionally connectable to one or more sensors that are configured to provide the aforementioned measurement data forward, if necessary.

RFID technology is often used in different product or human/animal tracking and/or control applications; e.g. in logistic applications the tags attached to moveable goods facilitate real-time monitoring of product status and location while the goods are being relocated or during storage. RFID tags shall preferably be light, small-sized, affordable, durable, and versatile. Such requirements are not particularly easy to implement in a single generic product, and the product development in the field has diverged into multiple directions depending on each application dictating its own requirements and preferences.

A number of solutions such as the one disclosed in publication WO2004/092999 have been set forth for providing RFID devices, wherein some form of WLAN technology is applied as a data transfer technology. Wireless local area networks (i.e. WLAN), e.g. the ones defined by IEEE 802.11 standard and its variants, have widely gained popularity during the last ten years, thanks to the obvious benefit of locally avoiding data transfer cables when coupling electrical devices together for communication purposes. WLAN solutions may exploit e.g. frequency hopping or direct spread approaches for utilizing the available frequency band that can be first allocated to a number of physically separate or frequency-wise overlapping sub-bands whereto the connections are then directed, each with different spreading parameters to avoid collisions and congestion. The effective data transfer rates of current WLAN solutions vary from one or few Mbit/s to the maximum of around one hundred Mbit/s. Feasible range still providing reasonable data rates varies from few tens of meters to few hundred meters depending on the environment.

Notwithstanding the obvious benefits provided by the modern communication technology in RFID-based monitoring and data collecting applications, scenarios still occur where further advances are welcome. For example, in a logistics center or terminal serving a plurality of arriving and departing vehicles that communicate with the center data transfer may become congested rather easily when a number of vehicles such as trucks reach a terminal substantially simultaneously and the data gathered by various tags carried by each truck should be suddenly read by the terminal equipment. In more sophisticated RFID solutions the RFID devices may transfer data over a short-range wireless network obeying the desired WLAN protocol, for example, but in the case of multiple, independent RFID devices simultaneously trying to access and transmit data over the same WLAN resources, the data transfer capacity and capacity to service simultaneous connections of the receiving WLAN equipment and logistics terminal is still rather easily exceeded. This may at least momentarily jam also the vehicle traffic. The resulting delays may cause considerable financial damages and traffic rush at the center, although the physical facilities such as lanes and parking lots might be reasonably dimensioned as such.

### SUMMARY OF THE INVENTION

The objective of the present invention is to avoid or at least alleviate the aforesaid drawbacks evident in the prior art arrangements concerning the use of multiple RFID devices.

The objective is achieved via the device, system and method of the present invention, whereby the device of the invention, a so-called “master device”, collects data from a number of RFID devices and then passes the data forward over WLAN based on receipt of an activation signal, e.g. activation message or one or more activation parameters or commands in a message, received from an external entity via RF reception means.

Accordingly, in one aspect of the present invention a device comprising a radio frequency receiving means, a wireless transmitting means operable in wireless local area network, a processing means for processing instructions and a memory means for storing data, is characterized in that said device is configured to receive data from a number of radio frequency identification (RFID) devices via said radio frequency receiving means, further configured to store said data in said memory means, configured to receive an activation signal from an external entity via said radio frequency receiving means, and finally configured to transmit said received data via said wireless transmitting means over a wireless local area network in response to said received activation signal.

In another aspect, a method for obtaining and forwarding data from a radio frequency identification device to be performed by a wireless communications-enabled device is characterized in that it comprises:
receiving, via radio frequency communication, data from a number of radio frequency identification devices,
storing said obtained data,
receiving, via radio frequency communication, an activation signal from an external entity, and
initiating, based on receiving said activation signal, transfer of said received data over a wireless local area network.

Still in a further aspect, a system for obtaining and forwarding data from a radio frequency identification device is characterized in that it comprises:
a number of radio frequency identification devices locatable to respective target locations, each of said radio frequency identification devices comprising a radio frequency transmitting means for sending data to a master device,
a master device comprising a radio frequency receiving means, a wireless transmitting means operable in wireless local area network, a processing means for processing instructions and a memory means for storing data, said master device being configured to receive data from said number of radio frequency identification devices via said radio frequency receiving means, further configured to store said data in said memory means, configured to receive an activation signal from an external entity via said radio frequency receiving means, and configured to transmit said received data via said wireless transmitting means over a wireless local area network in response to said received activation signal.

The device that receives the data from the number of RFID devices acting as tags may be a similar device itself just configured to act in a role of a master unit instead of a mere tag functionality, or it may be a different device configured to cooperate with the tags as a more capable master unit for obtaining data from the tags and passing them forward.

The radio frequency communication between the master device and RFID devices acting as tags may take place along a similar connection as the reception of the activation signal from the external entity, or the two transfer methods may differ from each other. The used communication technique may be a proprietary one or obey some national or internationally recognized standard as to be reviewed in more detail hereinafter.

The data provided by the number of RFID devices acting as tags may include ID and/or sensor data. The sensor data may be provided by a sensor incorporated or at least functionally connected to the corresponding RFID device.

The utility of the invention arises from a plurality of issues. Firstly, the RFID devices providing the data to the master device can be kept functionally and optionally also structurally simpler than otherwise as it is now the master device that preferably solely stores, optionally processes, and forwards the data using the WLAN. Likewise, the power consumption of the RFID devices acting as tags is reduced as their transmitter (e.g. transmission power) may be adjusted just for local short-range transmissions to the master device, which correspondingly lengthens the operation time thereof between battery changes or battery recharging, for example. Thirdly, collective storing and forwarding of data upon receiving an activation signal reduces unnecessary congestion of the WLAN network as the WLAN resources are allocated to the master device(s) only and the WLAN activation, e.g. resource allocation and/or initiation of data transfer, is performed utilizing a radio frequency channel external to the WLAN. The external entity sending the activation signal is preferably well aware of the WLAN status such as utilization level etc (the entity may poll the WLAN infrastructure to get status reports or the WLAN infrastructure may be configured to automatically send those) so that it may properly schedule activation of each near-by master device.

The expression “a number of” used herein refers to any positive integer starting from one. Accordingly, there may be one, two, or more radio-frequency identification devices in the number of RFID devices providing data to the master device in the solutions in accordance with the present invention.

In one embodiment of the invention a plurality of RFID devices are located in a truck for data retrieval according to a predetermined scenario. Each RFID may include a sensor that periodically obtains measurement data and passes it forward to the master device collecting and storing the data from the plurality of RFID devices. Upon entering a logistics center, the master device communicates with the terminal that sends an activation signal responsive to which the gathered data is transmitted over the WLAN to the logistics center acting for further analysis.

The term “wireless local area network” or “WLAN” is used in this patent application to preferably mean technology defined by IEEE 802.11 standard and its variants and successors, but it is also used to cover other possible wireless technologies which may be developed for similar purposes.

Various embodiments of the invention are disclosed in the attached dependent claims.

### BRIEF DESCRIPTION OF THE RELATED DRAWINGS

FIG. 1 visualizes the scenario of the first embodiment according to the present invention.

FIG. 2 is a block diagram of a device in accordance with one embodiment of the present invention.

FIG. 3 is a flow diagram of a method in accordance with one embodiment of the invention.

### DETAILED DESCRIPTION OF EMBODIMENTS

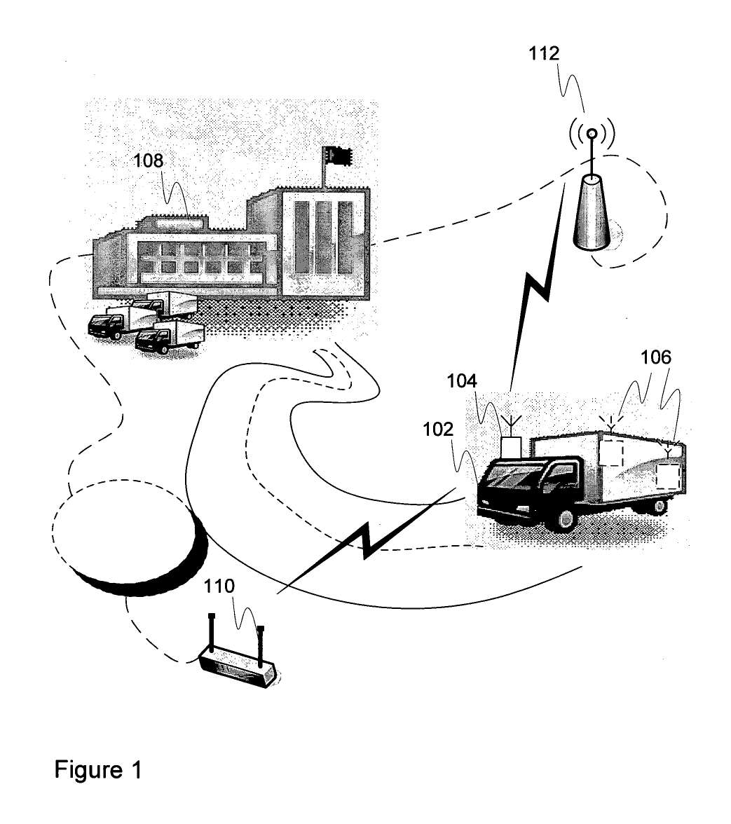

FIG. 1 depicts, by way of example only, one possible use of the present invention. A plurality of RFID devices 106 is located within a vehicle such as a truck 102. The RFID devices 106 act as tags and may be directly attached to target objects, e.g. products, that are being transported by the truck 102 or to the cargo space itself, e.g. to ceiling, floor, or walls thereof, so that they provide information on the conditions prevailing in the neighborhood of transported goods during the transportation.

A master device 104 receives data from the plurality of RFID tags 106 and stores it in the memory thereof. Optionally the master device 104 may also process the data by executing filtering, encoding, or analysis actions, for example. The master device 104 communicates with the plurality of RFID tags 106 through a compatible radio frequency technology that may be a proprietary one and tailored by the device supplier for each purpose, for example, or it may follow some more widely adopted communications standard. The master device 104 includes at least an RF receiver to capture the transmissions of the RFID tags 106, and preferably it also comprises a transmitter so that control messages and acknowledgments can also be directed towards the tags 106. In the case of both RF transmitter and receiver, they may be combined to a form a transceiver unit.

Further, the master device 104 includes a WLAN transceiver, preferably according to a desired standard so that upon entering a suitable time instant the data received from the tags 106 can be forwarded as such or in a processed form to a remote entity 110 such as the remote WLAN transceiver, e.g. an access point or a router, wherefrom it is further funneled to the logistics center/terminal 108 and/or to a further control center for analysis and/or control purposes. The remote WLAN transceiver 110 may reside within or at least functionally connected to the terminal of the logistics center 108. In a latter case it may reside connected to the Internet (note the exemplary dotted network entity in the figure), for example. The data provided over the W LAN may be stored in one or more databases and information systems of relevant entities, such as the logistics center 108 or a further control center. For example, the utilized W LAN standard by the IEEE (Institute of Electrical and Electronics Engineers) may be selected from a group consisting of: 802.11, 802.11a, 802.11b, 802.11 g, and 802.11n. Further, one or more of the extensions: 802.11e, 802.11F, 802.11d, 802.11h, 802.11i, and 802.11s may be used. Alternatively, Hiperlan 1 or 2 standards by ETSI (European Telecommunications Standards Institute) or any other suitable WLAN specification may be applied. The transceivers may support one or more WLAN specifications, whereupon a specific one can be selected for use via signaling over the RF connection.

The RF channel of the system can be used for activating the data transfer. In order to initiate the communications between the master device and the control center, it is possible that the master device transmits request messages at defined time intervals. These request messages may be transmitted on an RF channel of the system. When the master device enters the communication distance of a control center, the control center receives the request message of the master device. The control center then transmits communication parameters and other required commands preferably through the RF channel of the system. The data transfer may then start on e.g. WLAN connection. The transfer of collected data may still take place at a point of time which is determined by the control center.

It is possible that the data transfer between the master device and the control center is activated by the control center with an initial activation message, or it is possible that the data transfer is first initiated by the master device with a request message, after which the control center sends an activation message. In the system of FIG. 1 the data transfer is activated by the control center using the RF channel of the system. In order to initiate the communications between the master device and the control center, the control center transmits activation messages as broadcast messages on determined time intervals. The activation messages are transmitted on the RF channel of the system. When a master device enters within the communication range of a control center the master device will receive an activation message and start communication with the control center. The transfer of collected data may then be initiated at a suitable point of time. In this embodiment the activation messages are transmitted by the control centers or their base stations, and the coverage area of these RF transmissions is thus limited to the vicinity of the control centers or their base stations. On the other hand, if request messages are regularly transmitted by the master device, the RF transmission is spread into any areas where the master devices may travel. Therefore, the embodiment where the control center transmits activation messages causes a load on the RF channel which is more local than the embodiment where request messages are transmitted by the master device.

In one embodiment the suitable time instant for the data transfer can be solely or at least partially determined by an entity that controls sending of the activation message via the radio frequency transceiver or transmitter 112. The entity may be or at least reside within or functionally connected to the logistics center/terminal 108 so that it advantageously obtains knowledge about the suitable time instant (e.g. vacant time period not already used or allocated to other master devices) and optionally about suitable connection parameters for WLAN communication from the WLAN infrastructure or transceiver 110, for example. Same entity, e.g. logistics control system of center 108, may ultimately control both RF and WLAN connections and also receive the data sent by the master devices 104.

In one embodiment the activation signal is a message or e.g. a command or a parameter value in a message configured to immediately trigger data transmission between the master device 104 and the WLAN transceiver 110. In another embodiment the activation signal determines a time slot or instant in the future upon which the transmission over the WLAN should take place. The master device 104 may then comprise a clock or a timer functionality to locally take of starting the transmission according to the received instructions.

In one embodiment the activation signal determines a number of WLAN connection parameters instead of or in addition to the immediate triggering/delayed triggering function. Issuing connection parameters, e.g. used WLAN version information, password, login ID, or encryption information, may enable a connection setup to the WLAN network whereto connection establishment without the given parameters would have been either impossible or difficult by the master device 104.

The RF transfer method (e.g. communication parameters such as frequency and modulation, or other settings) used for communication between the transceiver 112 and the master device 104 may be similar to the technology used in the communication between the RFID tags 106 and the master device 104. Alternatively, these two types of transmissions may follow different scheme and require different software, software parameters, hardware (in the transceiver/receiver 204), or both. For example, in one embodiment the radio frequency communication from transmitter 112 utilizes relatively long-range, universal cellular standard such as GSM (Global System for Mobile Communications), GPRS (General Packet Radio Service), or UMTS (Universal Mobile Telecommunications System) whereas the transmissions by the RFID tags 106 follow a proprietary, shorter range and lower power consumption communication technique. In another embodiment both the transmission types utilize the same RF communication method, e.g. the proprietary one.

In one embodiment of the invention both the data transfer from the RFID devices to the master device as well as the data transfer from the master device to the control center are activated from outside the master device. In this embodiment, data transfer sequence from an RFID device (or router) to the master device is initiated from the RFID device/router, i.e. the RFID device/router provides the first transmission of the sequence. In the embodiment, the data transfer from the master device to the control center is initiated from the control center or some other point between the master device and the control center. The control center may first transmit an activation message allowing the master device to start data transfer immediately or on a defined point of time. When data transfer is initiated with transmission from outside the master device, it is possible to achieve an efficient use of data communications capacity as well as efficient use of power supplies.

In one embodiment the data transferred include ID information relating to the RFID tags 106 that, for their part, may be associated with certain locations in the cargo space or the transported goods. In another embodiment the data alternatively or additionally include sensor data, e.g. measurement data acquired from a sensor that is embedded in a tag 106 or at least functionally connected thereto. Each tag 106 may include one or more connectors and interfaces for connecting, either wirelessly or in a wired manner, to one or sensors, respectively. The sensors may incorporate functionalities for measuring temperature, pressure, acceleration, movement, shock, humidity, light, gas, electrical activity, chemical activity, etc.

For example, in the scenario of FIG. 1 the tags 106 may be include temperature and/or humidity measurement sensing function thanks to internal or externally connected corresponding sensors. The tags 106 and the related sensors are disposed on predetermined locations within the vehicle 102 so that the data obtained reflect the conditions for which the transported goods, being in this exemplary scenario e.g. foodstuff, are exposed. The tags 106 are programmed to transmit, one at a time, once per every x, e.g. ten, minutes period, the sensor readings to the master unit 104 for storage and forwarding, optionally also processing, purposes. Upon arrival at the vicinity, e.g. within communication range, of the destination logistics center 108 the master device 104 receives connection parameters from the RF transmitter or transceiver 112 so as to establish a WLAN connection with the WLAN transceiver 110 for forwarding sensor data to the logistics center 108. The data may prescribe how the foodstuff shall be handled at the center 108, i.e. when having suffered from overly warm conditions during the transportation, it may be necessary to dissipate the presumably spoiled food.

In one embodiment the RFID tags 106 are polled by the master device 104 for data. In another embodiment the RFID tags 106 are configured to either periodically or upon occurrence of a predetermined event (e.g. expiration of a timer, sensing a predetermined sensor value, error situation, or alarm) to wake up or at least activate and obtain sensor data and/or provide data to the master device 104.

In one embodiment of the invention, both the master device 104 and the tag devices 106 are similar and the separation between roles ‘master’ and ‘slave’ is preferably achieved programmatically, i.e. through different software or different parameters guiding the functioning of the software. The role is preferably remotely adjustable via the RF or WLAN connections. In a further embodiment the devices 104, 106 may be also configured as ‘repeaters’ or ‘routers’ for improving the range and enabling connecting to other networks, respectively.

Preferably the devices 104, 106 are active devices implying that they have a power source of their own or are at least connected to a power source at their deployment location. The power source may be a disposable or a rechargeable battery, for example. In alternative embodiment, one or more RFID tags 106 are at least partially passive, i.e. some of their functionalities are powered by the radio frequency signal radiated by the master device 104 or some other entity.

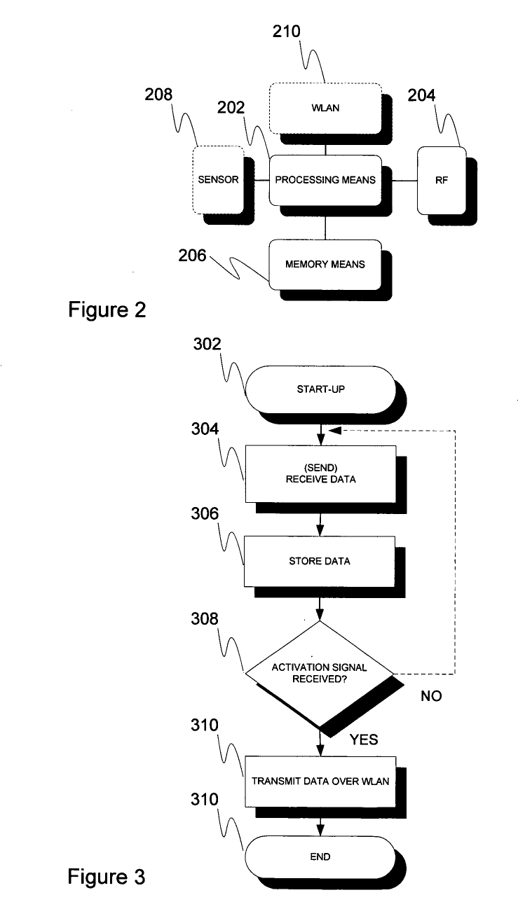

FIG. 2 discloses a functional block diagram of a device 104, 106 according to one embodiment of the present invention. The devices 104, 106 may incorporate one or more integrated circuit(s), processors, microprocessors, DSPs (digital signal processor), programmable logic or other processing means 202 for controlling the overall functionality thereof. The local RF transceiver (at least a transmitter is required in the tags 106 and a receiver in the master device 104) 204 enables communication between the master device 104 and the tags 106 and with the remote RF transceiver 112. The RF transceiver 204 may support multiple RF technologies as reviewed hereinbefore. The devices 104, 106 may further comprises non-volatile, e.g. ROM, and volatile, e.g. RAM, memory 206 implemented as one or more memory chips, for example, for storing instructions, e.g. an application, and other data such as ID and/or measurement data received via the optional sensors 208. The ID data may comprise address data that is unique to each device. The devices 104, 106 also have a power source or at least a connector for an external power source (not shown). Further, a UI means such as display and keyboard/keypad, or at least an interface for them, may be added for providing control means over the device functionalities (not shown).

The devices 104, 106 advantageously include one or more integrated sensors 208 or at least interfaces/connectors for connecting to the sensors 208 for data reception and/or enabling sensor 208 control actions. The WLAN transceiver 210 of the master device 104 and optionally also of tags 106 is used for WLAN communication as set forth hereinbefore. The skilled readers will appreciate that many other internal representations of the devices 104, 106 are also feasible for implementing the functionalities required for carrying out the tasks of the present invention. Various aforesaid elements of the device 104, 106 may be located on a circuit board the size of which is preferably minimized. Advantageously the size is selected only few tens of millimeters as to the length, width and thickness thereof, e.g. 45×35×10 mm, respectively.

RF data transfer as handled by the local RF transceiver 204 and optionally also the processing means 202 may include dividing data into packets of variable or predetermined length. In one embodiment the master device 104 is configured to acknowledge the receipt of data. In another, either supplementary or alternative, embodiment the data includes a checksum, e.g. CRC (Cyclic Redundancy Check) or a hash value, e.g. MD5, which is verified by the master device 104. In case of erroneous reception, the master device 104 asks for data retransmission from the associated tag 106.

Further, the data may be transferred as encrypted between the tags 106 and the master device 104 and the master device 104 and the WLAN 110 or RF 112 transceiver alike. The encryption may occur step-wise or in end-to-end fashion in which case the data is not deciphered by the master device 104 prior to forwarding over the WLAN. Encryption keys or other data may be stored in the devices 104, 106, 110, 112 as factory defaults or be configurable by the device user(s) either locally or via the available WLAN or RF connections. With devices 104, 106 the encryption/decryption functions may be controlled by the processing means 202 according to instructions, e.g. an application or a software module, stored in the memory means 206, for example. Also supplementary encryption/decryption chips may be utilized. The selected encryption method may be selected from a group consisting of: DES (Data Encryption Standard), AES (Advanced Encryption Standard), Diffie-Hellman, RSA (Rivest, Shamir, Adleman), IDEA (International Data Encryption Algorithm) and Blowfish, for example, or other unlisted method may be applied.

In one embodiment the transmission power and thus indirectly the power consumption of the tags 106 and the master device 104 is configurable so as to maximize the operation period between battery recharging or replacement operations and minimize the interference caused by the wireless communication to other elements.

In one embodiment the tags 106 comprise analogue inputs with ND conversion feature for obtaining sensor or other data. In another embodiment the tags 106 comprise digital inputs configured to directly co-operate with compatible digital outputs of the sensors or other attached devices. Also both analogue and digital inputs may be used.

FIG. 3 shows a flow diagram according to one embodiment of the method of the invention. The execution starts at 302, i.e. the start-up, wherein the master 104 device and tags 106 are switched on and located in the target areas or products, and necessary configuration adjustments are performed. At 304 the tags 106, e.g. one at a time according to an occurrence of a predetermined event such as an expiration of a timer, upon data input activity by an attached sensor or after receipt of a data request from the master device 104, send data such as ID and/or sensor data to the master device 104 that receives and then stores 306 the data locally. The master device 104 monitors predetermined RF channel(s) 308 so as to detect an activation signal sent by an external entity. The events 304-308 may be repeatedly performed. After receiving the activation signal the master device 104 initiates, either immediately or according to a received criterion, e.g. at a certain time instant, transfer of the received data or at least part thereof over a WLAN network as explained. Such initiation may require establishing first a WLAN connection with the remote party. Therefore the activation signal may trigger both immediate/delayed establishment of the WLAN connection and subsequent data transfer, or just the data transfer via already established connection. Parameters for establishing the WLAN connection may be predetermined and stored in the master device 104 or received in the activation or some other signal. The method execution is finally ended in phase 312, which may take place, in the visualized example of FIG. 1, upon arrival of the vehicle 102 at the logistics center 108, for example.

The scope of the invention is determined by the attached claims together with the equivalents thereof. The skilled persons will appreciate the fact that the explicitly disclosed embodiments were constructed for illustrative purposes only, and the scope will cover further embodiments and equivalents that better suit each particular use case of the invention.

1-20. (canceled)

21. A device comprising a radio frequency receiving means, a wireless transmitting means operable in wireless local area network, a processing means for processing instructions and a memory means for storing data, characterized in that said device is configured to receive data from a number of radio frequency identification devices via said radio frequency receiving means, further configured to store said data in said memory means, configured to receive an activation signal from an external entity via said radio frequency receiving means, and finally configured to transmit said received data via said wireless transmitting means over a wireless local area network in response to said received activation signal.

22. The device of claim 21, configured to receive ID data from said number of radio frequency identification devices.

23. The device of claim 21, configured to receive sensor data from said number of radio frequency identification devices.

24. The device of claim 21, configured to receive both said data and said activation signal utilizing a similar radio frequency communication method.

25. The device of claim 21, configured to receive said data utilizing a first radio frequency communication method and to receive said activation signal utilizing a second radio frequency communication method, wherein said radio frequency receiving means optionally includes a first transceiver and a second transceiver, respectively.

26. The device of claim 21, wherein said radio frequency means comprises a GSM (Global System for Mobile communications) and/or GPRS (Global Packet Radio Service) receiver.

27. The device of claim 21, configured to establish one or more parameters for WLAN communication on the basis of said activation signal.

28. The device of claim 21, configured to determine a time slot or time instant for WLAN transmission on the basis of said activation signal.

29. The device of claim 21, being a multi-purpose radio frequency identification device configured to the role of a master device.

30. The device of claim 21, configured to process said received data.

31. The device of claim 21, configured to execute at least one action selected from a group consisting of: transmit a data request to a radiofrequency identification device, transmit a retransmission request to a radio frequency identification device, encrypt data received from a radio frequency identification device, and decrypt data received from a radio frequency identification device.

32. A method for obtaining and forwarding data from a radio frequency identification device to be performed by a wireless communications-enabled device, characterized in that it comprises:
receiving, via radio frequency communication, data from a number of radio-frequency identification devices,
storing said obtained data,
receiving, via radio frequency communication, an activation signal from an external entity, and
initiating, based on receiving said activation signal, transfer of said received data over a wireless local area network.

33. The method of claim 32, wherein said data received comprise ID data or sensor data.

34. The method of claim 32, wherein both said data and said activation signal are received utilizing a similar radio frequency communication method.

35. The method of claim 32, wherein said data are received utilizing a first radio frequency communication method and said activation signal is received utilizing a second radio frequency communication method.

36. The method of claim 32, wherein said activation signal is received utilizing a GSM (Global System for Mobile communications) and/or GPRS (Global Packet Radio Service) reception method.

37. The method of claim 32, wherein one or more parameters for WLAN communication are established on the basis of said activation signal.

38. The method of claim 32, wherein a time slot or instant for WLAN transmission is determined on the basis of said activation signal.

39. The method of claim 32, wherein at least one action is performed, said action being selected from a group consisting of: transmit a data request to a radiofrequency identification device, transmit a re-transmission request to a radio frequency identification device, process data received from a radio frequency identification device, encrypt data received from a radio frequency identification device, and decrypt data received from a radio frequency identification device.

40. A system for obtaining and forwarding data from a radio frequency identification devices, characterized in that it comprises:
a number of radio frequency identification devices locatable to respective target locations, each of said radio frequency identification devices comprising a radio frequency transmitting means for sending data to a master device,
a master device comprising a radio frequency receiving means, a wireless transmitting means operable in wireless local area network, a processing means for processing instructions and a memory means for storing data, said master device being configured to receive data from said number of radio-frequency identification devices via said radio frequency receiving means, further configured to store said data in said memory means, configured to receive an activation signal from an external entity via said radio frequency receiving means, and configured to transmit said received data via said wireless transmitting means over a wireless local area network in response to said received activation signal.
